(19) United States
(12) Patent Application Publication
(10) Pub. No.: US 2014/0279174 A1
(43) Pub. Date: Sep. 18, 2014

(54) BUILDING DATA EXCHANGE SYSTEM AND METHOD

(71) Applicant: Skye Energy, LLC, Atlanta, GA (US)

(72) Inventor: John Bracey, Chamblee, GA (US)

(73) Assignee: Skye Energy, LLC, Atlanta, GA (US)

(21) Appl. No.: 14/209,045

(22) Filed: Mar. 13, 2014

Related U.S. Application Data
(60) Provisional application No. 61/780,848, filed on Mar. 13, 2013.

(51) Int. Cl. G06Q 30/06; G06Q 10/10

(52) U.S. Cl. CPC G06Q 30/0611; G06Q 10/103
USPC 705/26.4; 705/26.1

(57) ABSTRACT

Building data exchange system including a web-enabled electronic marketplace that can accumulate structured building system efficiency data through software enabled energy and water audits. The system can include a building energy simulation engine, and database of energy/water efficiency measures. This data can be made anonymous and can populate a confidential electronic database accessible to vendors of energy efficiency products and services, resulting in a more efficient marketplace to the benefit of vendors and building owners.

### CROSS-REFERENCE TO RELATED APPLICATION

This application claims priority to U.S. Provisional Patent Application No. 61/780,848, filed Mar. 13, 2013, entitled “ELECTRONIC MARKETPLACE USING COMMERCIAL BUILDING ENERGY AND WATER USAGE AUDIT DATA TO FACILITATE TRANSACTIONS BETWEEN BUILDING OWNERS AND VENDORS OF ENERGY EFFICIENCY PRODUCTS AND SERVICES,” which is incorporated herein by reference in its entirety.

### TECHNICAL FIELD

Generally, the invention relates to the field of building energy efficiency, and specifically to utilizing accumulated data from energy audits to promote and facilitate efficient marketplace transactions between building owners and vendors of energy efficient products and services.

### BACKGROUND

According to the Commercial Building Energy Consumption Survey (2003), the commercial building sector in the United States consists of 4.8 million commercial buildings, totaling 71 billion square feet. A substantial portion of this space uses energy inefficiently.

Various tools are available to facilitate and standardize energy audits. Utilities are more likely to offer audit programs if they are low cost, high value, and do not require highly technical employees to perform more complex parts of the audit. As audits become more effective and less expensive, and as efficiency technology and energy costs make projects more economically attractive, the overall participation in the energy efficiency market will increase, to the benefit of both energy consumers and society as a whole.

A limitation to the ultimate effectiveness of current energy audits is the level of effort necessary for the building owner to convert audit recommendations into fully specified and competitively bid projects. Existing energy audit methods and systems typically end with a report given to the building owner. At that point, the building owner must seek vendors of efficiency products and services to implement the varying types of potential energy saving measures, perhaps getting multiple competitive bids.

Furthermore, there may be opportunities or newer technologies that could address issues identified in an audit that neither the auditor nor the building owner are aware of, limiting the scope of opportunities to the knowledge base of the auditor and the owner.

Vendors with current “state of the art” knowledge and products, on the other hand, can only approach the market in a relatively inefficient generalized manner, since they do not have access to information regarding the specific needs and characteristics of particular structures. When they are engaged by the building owner they often repeat much of the on-site effort already performed by the auditor in order to formulate their proposal.

In reality, the substantial effort required of the building owner to finalize and price projects and the effort required for vendors to identify and qualify market opportunities acts as a barrier that slows and inhibits implementation of economically feasible energy efficiency projects.

### SUMMARY

Described herein is a building data exchange system that provides methods for performing and utilizing building energy audits. In one embodiment, a web-enabled electronic marketplace implemented through a building data exchange system may accumulate structured building system efficiency data and build models from software enabled energy audits to populate a confidential database accessible to vendors of energy efficiency products and services.

The invention thus may comprise an electronic building data exchange system that can help building owners realize the benefits of energy audits by providing an efficient method to obtain and screen proposals for products and services targeted to their specific energy efficiency needs, while at the same time giving vendors of such products and services access to the data needed to efficiently identify and pre-qualify customers.

The details of one or more embodiments of the disclosure are set forth in the accompanying drawings and the description below. Other features, objects, and advantages of the disclosure will be apparent from the description and drawings, and from the claims.

### BRIEF DESCRIPTION OF THE DRAWINGS

The components in the drawings are not necessarily to scale relative to each other. Like reference numerals designate corresponding parts throughout the several views.

FIG. 1 illustrates a computing device that may perform the methods of a building data exchange system according to an implementation of the invention,

FIG. 2 illustrates a method of gathering electronic information using a building data exchange system according to an implementation of the invention;

FIG. 3 illustrates a method of creating a web based marketplace platform using a building data exchange system according to an implementation of the invention.

### DETAILED DESCRIPTION

Certain terminology is used herein for convenience only and is not to be taken as a limitation on the present invention. A number of examples are provided, nevertheless, it will be understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms.

### Scope of Terminology Used in Detailed Description

The description “energy” used in the description of the invention can also refer to any utility consumed by the building, including electricity, natural gas, propane, water, sewer service, waste, etc.

The description “building” may be refer to other facilities utilizing energy.

The description “building owner” includes the legal owner of a building, and may also include any tenant or other occupant who may directly or indirectly benefit from energy efficiencies.

The description “commercial building” generally means any building other than single family or town homes. However, the invention may also function in the single family market, with modification based on different products and economics.

The descriptions “data” or “building data” used throughout this document refers to information with respect to specific building characteristics and systems. This includes, but is not limited to, information such as building usage, building dimensions, envelope assemblies and dimensions, heating, ventilation, and cooling system types (model, capacity, efficiency and age, quantity, controls, etc.), lighting systems (type, quantity, efficiency, etc.), details of other energy consuming equipment, historic utility consumption and cost data, and other information relevant to the amount, type and source of energy consumed or required.

The description “audit platform” or “audit software” refers to the software and/or hardware that is used by the auditor, building owner and vendors to, perform the audit, populate building data, maintain and utilize the accumulated data and energy models, find prospective clients, and to submit and evaluate proposals.

The descriptions “vendor” or “service provider” includes individuals and entities of all types (commercial or non-profit) offering or providing energy efficiency equipment or other products, or energy efficiency services of any type. Also included may be educational, research or governmental organizations or units seeking access to accumulated data for research or analysis.

### Exemplary Embodiments of the Building Data Exchange System and Method

An exemplary web-based marketplace for building energy and water efficiency projects in accordance with the present disclosure can substantially increase the efficiencies in the market by easily and appropriately connecting buyers (building owners) and sellers (vendors or service providers) targeting energy improvements.

This is accomplished initially by capturing structured building data electronically through an audit software platform, which may be a part of the electronic building data exchange system implemented in software and/or hardware. This effort is an integral part of a conventional energy audit and is not intended to represent additional effort or cost. Using this data, along with a building simulation engine and local weather data, a building simulation model may be created by the building data exchange system. The data, the simulation model, and resulting database of opportunities are used to identify specific efficiency opportunities.

The structured building data, model, and opportunities may then be made accessible through a web-based platform that may also be provided by the building data exchange system. The system removes identifiable information from the building data, allowing the building owner to freely share building data with the marketplace while keeping personal and building identity anonymous.

Qualified vendors and service providers can then be given secured access to the web-based platform, for the purpose of identifying building characteristics and opportunities likely to support a business case for their services and products. The service provider can then request more detailed access to the full building data and simulations from the building owner. Once approved by the building owner, the vendor can do further analysis and submit detailed proposals.

The building owner can receive proposals through a web-based portal provided by the system, where various opportunities and preliminary proposals can be screened. Contact information can be sent to the vendors with whom the building owner desires direct contact and follow up.

### Structured Building Data Capture

One example aspect of the present disclosure is the energy audit software system itself, which is the first step in capturing detailed building data in an electronic format. One unique aspect of the energy audit software is that a functional part of the building data exchange system can customize the collection of the electronic building data to integrate with the rest of the components of the system, which is necessary for the marketplace to operate on an efficient basis.

Alternatively, however, building data can come directly from data such as building system plans, schedules, counts, and other documentation provided directly by the building owner. This can be captured electronically independent of a full energy audit, and fed into the energy model and marketplace provided by the system, as described below.

The data is categorized in a manner to allow it to both be used as an input to the energy models, as described below, and so that it can be analyzed independently with respect to specific systems, quantities, or usage types by service providers. An example of this would be lighting fixtures. In a typical audit, the fixture wattage, quantity, and typical operating schedule are required to accurately calculate lighting energy consumption. From here, a more efficient lighting fixture could be compared, and resulting energy savings calculated. However, a lighting contractor would typically need more information to put together a budgetary proposal. They might require the specific fixture type, the areas in which it is used in (e.g., offices, storage, hallways, etc.), and other detail. The energy audit software that can be provided by the system captures data in a way that it is time efficient for the auditor, while also allowing it to be organized in the web-based marketplace platform in sufficient detail for the service provider to use in qualifying an opportunity and preparing a proposal.

One unique aspect of this portion of the invention is thus capturing data in a manner that is both useful in the sense of a conventional energy audit, while also customized to provide the additional detail that allow the marketplace to function.

### Integrated Building Energy Simulation Engine

Another exemplary aspect of the present disclosure is the use of a building energy simulation engine that allows the auditor, building owner, and vendors to all utilize the same building data applied to the same building simulation. Time and effort are saved, in that the auditor uses a system in which building data capture software and the building simulation engine are integrated. More importantly and unique to this particular embodiment of the invention, the vendors' calculations are driven by the same inputs and assumptions utilized by the auditor and validated by the building owner. This is described in more detail below.

### Anonymous Access by Vendors and Service Providers

Another exemplary aspect of the present disclosure is the method of allowing anonymous and staged access of detailed electronic building information to the marketplace of applicable vendors. The building identity and property contact data is either removed or anonymized, so that the specific building cannot be identified. The building owner is typically more comfortable participating in sharing of data where he or she can control if and when contact is made, and can pre-screen opportunities presented.

### Staged Sharing of Building Data

Another exemplary aspect of the present disclosure is that building data can be shared in multiple stages. For example: first a building systems summary, and then detailed access at a second stage. The building systems summary contains detailed summaries of the building systems that are most useful to the marketplace in determining whether there may be viable efficiency projects that can be addressed. Detailed data access is access to the full spectrum of building data and building models that were derived from the audit. The service provider can peruse any building's anonymous building system summary data freely, but can be required to request access from the building owner to view detailed systems data.

Stages of access are organized to allow the building owner to choose which vendors can view more detailed data, for the purpose of allowing the vendor to more specifically confirm whether its services and/or products may be applicable and viable, and whether it wishes move forward with a detailed proposal.

### Electronic Building Database

Another exemplary aspect of the present disclosure is that the electronic building database allows service providers to electronically search for buildings that they can pre-qualify as potentially viable customers. As the number of buildings and the corresponding volume of available data in the marketplace grows, use of the marketplace becomes dramatically more efficient for the service provider and the building owner. For example, a lighting contractor would be able to see from the system summary that a specific building has 400 lighting fixtures of a particular type, the annual energy consumption and associated cost. The contractor could determine immediately whether these fixtures result in retrofit opportunities that it can viably address with its specific lighting technologies. If the data did not support an economically viable solution, the contractor would avoid unnecessary effort to pursue the opportunity. In this example, the building owner would not need to take any action, or even know that the vendor's analysis had taken place. Nevertheless, both parties would have benefited.

If the vendor identifies a potentially viable opportunity, the vendor can request access to the detailed data from the building owner. This request is electronic, and maintains the anonymous nature of the data. The building owner would be notified, and would then engage with the audit platform to view the request, and either accept or decline. Accepting the request would allow the specific vendor to access full detailed building data. Declining would inform the vendor that the building owner is not interested in the services or products, with the opportunity to provide specific feedback on why the request was declined.

### Analysis and Calculations by Vendor or Service Provider

Another exemplary aspect of the present disclosure is that vendors, once given detailed access to the building data, can perform specific efficiency measure calculations utilizing the very same inputs, assumptions, and energy model created by the auditor and validated by the building owner. This brings a high level of consistency to proposals from varying vendors. This benefit culminates in reduced effort on the part of the building owner to validate final projects that are ready to implement, and increases the likelihood of actual implementation.

### Proposal Submission by Service Provider and Review by Building Owner

Another exemplary aspect of the present disclosure is the method of allowing vendors, who have been given access by the building owner to the building data and energy model, to submit very specific proposals for their efficiency services and/or products to the building owner via the audit platform, before there has been direct contact and while the identity of the building and contacts may still be unknown. The building owner is notified of new proposals through the audit platform, where specifics of the proposals can be reviewed. Feedback and further communication may also be accomplished through the platform, until the building owner and service provider elect to initiate direct contact.

### Exemplary Methods and Structure

FIG. 2 provides an example method for gathering building audit data according to an exemplary embodiment of the system described above. At step 205, the audit or building data capture process begins, gathering paper and electronic information about the building systems including for example, energy and water usage and cost history (typically utility bills), and correlated hourly or daily weather data. This data can take many forms including structured data, disparate data, and unstructured data. At step 210, the building system data, utility data, and weather data can be captured into the audit software, structuring it into standardized format that allows for simulation and other analysis. At step 215, the captured building data can be used to simulate the energy and water usage of the building and can be calibrated to the actual measured usage, typically done over an annual basis. At step 220, the internal database of current standard efficiency opportunities can be applied to the building simulation to measure their energy and water saving potential. Cost estimates for implementing the particular measures can also calculated based on the capture data and typical market costs for the particular measure. At step 225, the initial building evaluation is complete, and the structured building data, simulation results, and efficiency opportunities can be stored electronically for ongoing access and analysis by the building owners and consultants. At step 230, the data can be filtered and made unidentifiable as needed such that it can be accessed and utilized by the vendors in the marketplace. This is described in more detail herein, and illustrated in the exemplary embodiment provided in FIG. 3.

FIG. 3 provides an example method for using a web-based marketplace according to an exemplary embodiment of the system described above. At step 305, the building data, simulation, and identified efficiency opportunities can be summarized and made anonymous so that they may be utilized by vendors in the marketplace. At step 310, this data can then be searched and analyzed by the vendors to help identify buildings and projects where they could offer a compelling service or product. At step 315, once the vendor has decided whether the building has viable projects to pursue, they can request access to the detailed data, simulation, and energy and water consumption history from the building owner. This request can be done electronically, maintaining the anonymity of the building owner. At step 320, the vendor may also decide that the building does not have viable projects, and can choose not to request access. At step 325, the building owner may not have had to expend any time, or even be aware of, the vendor's initial analysis and decision not to pursue. At step 330, assuming the vendor does request access, the building owner will receive the electronic communication, whose identity and project summary can be made available to the building owner. At step 335, the building owner can choose whether to allow access to the particular vendor, deny access, or push out the request to a later date if desired. This choice occurs via electronic communication within the marketplace platform. At step 340, assuming the building owner chooses to deny detailed access, then the vendor solicitation is stopped, the building anonymity is maintained, and feedback can be provided concerning the reason for the decline. At step 345, assuming the building owner responded in the marketplace platform that they are not ready for this type of product/service, the vendor can be alerted to come back and request access at a future date, specified by the building owner. At step 350, assuming the building owner chooses to grant detailed access to the building data, the vendor can then access subsets of or complete captured building data, simulations, and identified opportunities. The building owner can choose at this step whether to allow their building identity and contact details to be made available, or remain anonymous. At step 355, the vendor can then utilize this data to put together their own project details, either matching one identified in the audit, or a new one that was not identified with in the audit. These project details can be captured within the marketplace platform, utilizing the same data, assumptions, and building simulation engine, allowing time savings and consistency between the audit and multiple vendors offering similar projects. At step 360, the building owner can then receive an electronic communication giving notification of the new proposal in the marketplace platform. The building owner can review the proposal details, which can include details such as project costs, utility cost and consumption savings, product and service details, external electronic documents, or other materials typically used in a proposal. This can all captured within the marketplace, or linked to external resources (e.g., external vendor website). In step 365, the building owner can chose to pursue the project, and their building identity and contact details are provided electronically to the vendor, if they are still anonymous. At step 370, the building owner and vendor can now complete the process in a typical fashion with site visits, final pricing, etc. At step 375, assuming the building owner responded in the marketplace platform that they are not ready to act on the submitted proposal, the vendor can be alerted to come back and request an update at a future date, specified by the building owner. At step 380, assuming the building owner has responded that they are not interested in pursuing the proposal, feedback can be provided by the building owner as to the reasons for the decision, and the vendor's solicitation is stopped.

FIG. 1 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that performs particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing aspects described herein includes a computing device, such as computing device 100. In its most basic configuration, computing device 100 typically includes at least one processing unit 102 and memory 104. Depending on the exact configuration and type of computing device, memory 104 may be volatile (such as random access memory (RAM)), non-volatile (such as read-only memory (ROM), flash memory, etc.), or some combination of the two. This most basic configuration is illustrated in FIG. 1 by dashed line 106.

Computing device 100 may have additional features/functionality. For example, computing device 100 may include additional storage (removable and/or non-removable) including, but not limited to, magnetic or optical disks or tape. Such additional storage is illustrated in FIG. 1 by removable storage 108 and non-removable storage 110.

Computing device 100 typically includes a variety of computer readable media. Computer readable media can be any available media that can be accessed by device 100 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 104, removable storage 108, and non-removable storage 110 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of computing device 100.

Computing device 100 may contain communications connection(s) 112 that allow the device to communicate with other devices. Computing device 100 may also have input device(s) 114 such as a keyboard, mouse, pen, voice input device, touch input device, etc. Output device(s) 116 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for providing an electronic marketplace for the exchange of building data, the method comprising:
receiving, by a building data exchange system, structured building data associated with a building owned by a building owner;
categorizing, by the building data exchange system, the structured building data such that the structured building data is useable by an integrated building simulation engine and independently analyzable by an interested third-party;
generating, by the building data exchange system, a building simulation model based on both the integrated building simulation engine and the structured building data;
populating, by the building data exchange system, a database according to calculations performed by the building simulation model, wherein the populated database is accessible through a communication interface associated with the electronic building data exchange system; and
providing, by the building data exchange system, a predetermined level of access to the populated database to the interested third party.

2. The method of claim 1, wherein the provided predetermined level of access is limited access.

3. The method of claim 1, wherein the provided predetermined level of access is access anonymous access.

4. The method of claim 1, wherein the provided predetermined level of access is full access.

5. The method of claim 1, further comprising:
receiving, by the building data exchange system, a request for additional access from the interested third party;
determining, by the building data exchange system, whether to accept the request for additional access; and
providing, by the building data exchange system, a second predetermined level of access to the populated database to the interested third-party.

6. The method of claim 5, wherein the provided second predetermined level of access allows the interested third party limited access to the populated database.

7. The method of claim 5, wherein the provided second predetermined level of access allows the interested third party to access anonymous building data associated with the populated database.

8. The method of claim 5, wherein the provided second predetermined level of access allows broader access to the populated database as compared to the provided predetermined level of access.

9. The method of claim 8, wherein the provided second predetermined level of access allows the interested third party full access to the populated database.

10. The method of claim 8, wherein determining whether to accept the request for additional access comprises:
forwarding, by the building data exchange system, the request for additional access to the building owner; and
determining, by the building data exchange system, whether the building owner accepted the request, wherein the request for additional access is presentable to the building owner through a computing device associated with the building owner.

11. The method of claim 10, wherein the provided second predetermined level of access is limited access.

12. The method of claim 10, wherein the provided second predetermined level of access is anonymous access.

13. The method of claim 10, wherein the provided second predetermined level of access allows the interested third party full access to the populated database.

14. The method of claim 1, further comprising:
receiving, by the building data exchange system, a proposal from the interested third-party; and
sending, by the building data exchange system, the proposal to the building owner wherein the proposal is for efficiency services and the proposal is presentable on a computing device associated with the building owner.

15. The method of claim 1, further comprising:
receiving a proposal from the interested third-party; and
sending the proposal to the building owner wherein the proposal is for efficiency services and the proposal is presentable on a computing device associated with the building owner.

16. The method of claim 14, wherein the proposal is presentable on a computing device associated with the building owner.

17. The method of claim 15, wherein the proposal is presentable on a computing device associated with the building owner.

18. The method of claim 1, further comprising:
receiving, by the building data exchange system, a proposal from the interested third-party; wherein the proposal is for efficiency products; and
Sending, by the building data exchange system, the proposal to the building owner.

19. The method of claim 1, wherein the structured building data is received through an audit software platform configured with the building data exchange system.

20. The method of claim 1, wherein the structured building data is received by the building data exchange system from a computing device associated with the building owner.
